(19) United States
(12) Patent Application Publication
(10) Pub. No.: US 2024/0098687 A1
(43) Pub. Date: Mar. 21, 2024

(54) WIRELESS DEVICE FEARED EVENT OBSERVATIONS AND INDICATORS

(71) Applicant: Telefonaktiebolaget LM Ericsson (publ), Stockholm (SE)

(72) Inventors: Fredrik GUNNARSSON, Linköping (SE); Ritesh SHREEVASTAV, Upplands Väsby (SE); Pradeepa RAMACHANDRA, Linköping (SE); Sara MODARRES RAZAVI, Stockholm (SE)

(21) Appl. No.: 18/260,984

(22) PCT Filed: Jan. 14, 2022
(86) PCT No.: PCT/SE2022/050037

§ 371 Date: Jul. 11, 2023

Related U.S. Application Data
(60) Provisional application No. 63/137,601, filed on Jan. 14, 2021.

(51) Int. Cl. H04W 64/00; H04W 24/08; H04W 76/20

(52) U.S. Cl. CPC H04W 64/006; H04W 24/08; H04W 76/20

(57) ABSTRACT

A method, system and apparatus are disclosed for wireless device (WD) feared event observations and indicators. In one embodiment, a network node is configured to determine a regional local environment integrity indicator; and send the determined regional local environment integrity indicator to the wireless device. In one embodiment, a wireless device is configured to obtain assistance data and a regional local environment integrity indicator; and determine positioning integrity based on the regional local environment indicator.

### FIELD

The present disclosure relates to wireless communications, and in particular, to arrangements for wireless device (WD) feared event observations and indicators.

### BACKGROUND

Positioning in 3^{rd} Generation Partnership Project (3GPP) 4^{th} Generation/Long Term Evolution/Evolved Packet core (4G/LTE/EPC) and 5^{th} Generation/New Radio/5G core (5G/NR/5GC) is supported by the architecture in FIG. 1, with direct interactions between a wireless device (WD, also called user equipment or UE) and a location server 2 via the LTE Positioning Protocol, LPP. Moreover, there are also interactions between the location server 2 and the serving radio base station (BS) 4 via the LPPa protocol, to some extent supported by interactions between the radio base station 4 and the WD via the Radio Resource Control (RRC) protocol. The radio base station 4 interacts with a mobility network entity (MNE) 6 via a first interface protocol (also referred to as a “1^{st} interface”), and the mobility network entity 6 interacts with the location server 2 via a second interface protocol (also referred to as a “2^{nd} interface”). In some applications, the location server interacts with a GNSS correction data provider 8 via a third interface protocol (also referred to as a “3^{rd} interface”).

In 3GPP LTE

In 4G/LTE/EPC and 5G/NR/5GC, the servers/nodes/functions/interfaces/protocols are named as follows:

| Generic name | Name in 4G/LTE/EPC | Name in 5G/NR/5GC |
|---|---|---|
| Location | Evolved Serving Mobile | Location Management |
| server 2 | Location Center (E-SMLC) | Function (LMF) or SLP |
| | or SLP | |
| Radio base | eNodeB | gNodeB |
| station (110) | | |
| Mobility network | Mobility Management | Access and Mobility |
| entity (120) | Entity (MME) | Management Function |
| | | (AMF) |
| First interface | S1-MME | N2 |
| (153) | | |
| Second interface | SLs | NL1 |
| (154) | | |

In both cases, the location server 2 can also be interacting with the WD directly over user plane communication carrying LPP with signaling defined by Open Mobile Alliance (OMA) Secure User Plane Location (SUPL) or some other user plane signaling. In case of SUPL, the location server 2 is denoted SUPL Location Platform (SLP) and the WD is denoted SUPL Enabled Terminal (SET).

There are several options for the interface, signaling and message handling over the third interface between the location server 2 and a correction data provider 8. One option is message handling defined by Radio Technical Commission for Maritime (RTCM) special committee with the user plane signaling protocol Networked Transport of RTCM via Internet Protocol (NTRIP). RTCM SC initially defined differential corrections to GNSS.

3GPP Release 9 (Rel 9) introduced support for assisted Global Navigation Satellite System (GNSS), and the scope of the assistance data has been refined over the releases. In Release 5 (Rel 15), support for Real Time Kinematics (RTK) GNSS was introduced. The assistance data is generated based on observations from one or more reference stations, where a reference station is a node with known position and known antenna configuration, and a GNSS receiver capable of measuring signals from one or more satellite systems, where the satellite systems comprise one or more satellites, and each satellite transmits one or more signals. Typically, the GNSS RTK assistance data is provided by a separate function, correction data provider or NRTK server.

GNSS represents a generic system, with examples GPS, GLONASS, GALILEO and BeiDou. These systems are based on a number of GNSS satellites, each transmitting Global Navigation Satellite System (GNSS) signals associated to a specific GNSS signal identity. The satellites follow tailored orbits around the globe.

FIG. 2 illustrates an example of the different 4G/LTE/EPC and 5G/NR/5GC entities in another architecture, including a home subscriber system (HSS), unified data management (UDM), location service (LCS) client, Gateway Mobile Location Center (GMLC), mobility management entity (MME), Enhanced Serving Mobile Location Center (E-SMLC), Evolved Universal UMTS Terrestrial Radio Access Network (E-UTRAN), network exposure function (NEF), location management function (LMF), application function (AF), access and mobility management function (AMF) and radio access network (RAN).

5G positioning methods based on 5G signals may be realized with downlink positioning reference signals, associated to a specific radio resource, which may be transmitted using a radio beam with directivity. Each positioning reference signal is associated to an identifier. One or more such signals are transmitted from a specific transmission point associated to a radio base station.

Positioning methods rely on measurements, and several positioning methods rely on device measurements of GNSS signals, Wi-Fi signals, Bluetooth signals, beacon signals, radio access technology (RAT)-dependent signals, etc. Such device measurements are subject to errors or feared events, and a subset of such errors or feared events are due to the local environment of the device.

FIG. 3 illustrate one typical example of a local environment error or feared event—multipath signal propagation. On the left side, some GNSS signals are received via a line of sight path and some via a reflected non-line of sight path; the right side of FIG. 3 illustrate a similar situation for a terrestrial radio network, where some signals are received via a line of sight path and some via a reflected non-line of sight path. The time of flight of a non-line-of-sight signal does not reflect the distance between the transmitter and device, leading to a measurement error due to the local environment of the device.

Other examples of local environment measurement issues, but not limited to, are:
unintentional interference from other radio transmitters;
intentional interference from other radio transmitters, often denoted jamming; and/or
intentional fake radio signals to lure the device to measure radio signal time of flight not corresponding to reality, often referred to as spoofing.

MDT

Minimization of drive test (MDT) is used as an alternative to the drive tests for obtaining certain types of WD measurements results for self-organizing network (SON) related features such as network planning, network optimization, network parameter tunning or setting (e.g., base station transmit power, number of receive and/or transmit antennas etc.), or even for positioning (e.g., radio frequency (RF) pattern matching based positioning). The WD is configured by the network for logging the measurements. Two MDT modes exist: immediate MDT and logged MDT:
Immediate MDT comprising measurement performed by WD in the high radio resource control (RRC) activity states (e.g., RRC CONNECTED state in LTE and NR etc.) and the reporting of the measurements to a network node (e.g., eNodeB, gNode B etc.) when reporting condition is met, e.g., event is triggered.

Logged MDT functionality comprising measurement performed by WD when operating in a low radio resource control (RRC) activity state (e.g., RRC idle, RRC inactive etc.). The network uses Logged Measurement Configuration message to configure the WD to perform logging of measurement results in low RRC activity state which can be stored in the WD for up to 48 hours before reporting. The configuration comprises information such as absolute time in the cell, logging duration, logging interval or periodicity (e.g., how often the measurements are logged), information about area where logging is required etc. The logging duration can vary from few minutes to several hours. The WD transmits the measurement results along with relative time stamp for each log, which indicates the time of logging measurement results relative to the absolute time received (received from the network), location information of the logged results (optional), etc.

### SUMMARY

Some embodiments advantageously provide methods, systems, and apparatuses for arrangements for wireless device (WD) feared event observations and indicators.

In one embodiment, a network node is configured to determine a regional local environment integrity indicator; and send the determined regional local environment integrity indicator to the wireless device.

In one embodiment, a wireless device is configured to obtain assistance data and a regional local environment integrity indicator; and determine positioning integrity based on the regional local environment indicator.

According to an aspect, a method implemented in a network node is provided. The method includes determining a regional local environment integrity indicator; and sending the determined regional local environment integrity indicator to a wireless device, WD.

In some embodiments, the method further includes receiving a report from the WD, the report indicating at least one local environment measurement issue, the regional local environment integrity indicator being determined based on the at least one local environment measurement issue. In some embodiments, the at least one local environment measurement issue is detected by the WD by comparing different positioning measurements and estimating at least one measurement error based on the comparison. In some embodiments, sending the regional local environment integrity indicator together with assistance data to the WD, the regional local environment integrity indicator indicating a positioning integrity associated with an estimated position of the WD, and the estimated position of the WD being based on the assistance data.

In some embodiments, receiving the report from the WD as part of a Long-Term Evolution, LTE, Positioning Protocol, LPP, message and as a result of a request from the network node. In some embodiments, the request comprises a provide location information message from the network node to the WD. In some embodiments, receiving the report from the WD via a radio resource control, RRC, signaling, as a result of a trigger. In some embodiments, the trigger comprises at least one a request from a mobility network entity, MNE, a measurement issue detection and an expiration of a monitoring time window. In some embodiments, receiving the report from the WD, as a result of at least one of a pre-configuration and a configuration of the WD.

In some embodiments, the method further includes receiving information indicating a capability of the WD to monitor and report about local environment measurement issues. In some embodiments, the information indicating the capability of the WD to monitor and report about the local environment measurement issues is pre-configured at the WD. In some embodiments, the regional local environment integrity indicator is represented by at least one of a geographical reference and a measurement issue event.

According to another aspect, a method implemented in a wireless device, WD, is provided. The method includes obtaining assistance data and a regional local environment integrity indicator; and determining a positioning integrity based on the regional local environment indicator.

In some embodiments, the method further includes estimating a position of the WD based on the determined positioning integrity. In some embodiments, the method further includes sending a report to a network node, the report indicating at least one local environment measurement issue, the regional local environment integrity indicator being based on the at least one local environment measurement issue. In some embodiments, the method further includes detecting the at least one local environment measurement issue by comparing different positioning measurements and estimating at least one measurement error based on the comparison.

In some embodiments, sending the report to the network node as part of a Long-Term Evolution, LTE, Positioning Protocol, LPP, message and as a result of a request from the network node. In some embodiments, the request comprises a provide location information message from the network node to the WD. In some embodiments, sending the report to the network node via a radio resource control, RRC, signaling, as a result of a trigger. In some embodiments, the trigger comprises at least one a request from a mobility network entity, MNE, a measurement issue detection and an expiration of a monitoring time window. In some embodiments, sending the report to the network node, as a result of at least one of a pre-configuration and a configuration of the WD.

In some embodiments, the method further includes sending information indicating a capability of the WD to monitor and report about local environment measurement issues to the network node. In some embodiments, the information indicating the capability of the WD to monitor and report about the local environment measurement issues is pre-configured at the WD. In some embodiments, the regional local environment integrity indicator is represented by at least one of a geographical reference and a measurement issue event.

According to yet another aspect, a network node comprising processing circuitry is provided. The processing circuitry is configured to cause the network node to perform any one or more of the methods above.

According to yet another aspect, a wireless device, WD, comprising processing circuitry is provided. The processing circuitry is configured to cause the WD to perform any one or more of the methods above.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of LTE positioning architecture;

FIG. 2 illustrates an example of the different 4G/LTE/EPC and 5G/NR/5GC entities in an architecture;

FIG. 3 illustrates an example of signals that GNSS satellites transmit;

FIG. 4 is a schematic diagram of an exemplary network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating exemplary methods implemented in a communication system including a host computer, a network node and a wireless device for executing a client application at a wireless device according to some embodiments of the present disclosure;

FIG. 7 is a flowchart illustrating exemplary methods implemented in a communication system including a host computer, a network node and a wireless device for receiving user data at a wireless device according to some embodiments of the present disclosure;

FIG. 8 is a flowchart illustrating exemplary methods implemented in a communication system including a host computer, a network node and a wireless device for receiving user data from the wireless device at a host computer according to some embodiments of the present disclosure;

FIG. 9 is a flowchart illustrating exemplary methods implemented in a communication system including a host computer, a network node and a wireless device for receiving user data at a host computer according to some embodiments of the present disclosure;

FIG. 10 is a flowchart of an exemplary process in a network node according to some embodiments of the present disclosure;

FIG. 11 is a flowchart of an exemplary process in a WD according to some embodiments of the present disclosure;

FIGS. 12, 13 and 14 are flowcharts of examples processes according to some embodiments of the present disclosure;

FIG. 15 is a signaling diagram according to some embodiments of the present disclosure; and

FIGS. 16 and 17 are flowcharts of examples processes according to some embodiments of the present disclosure.

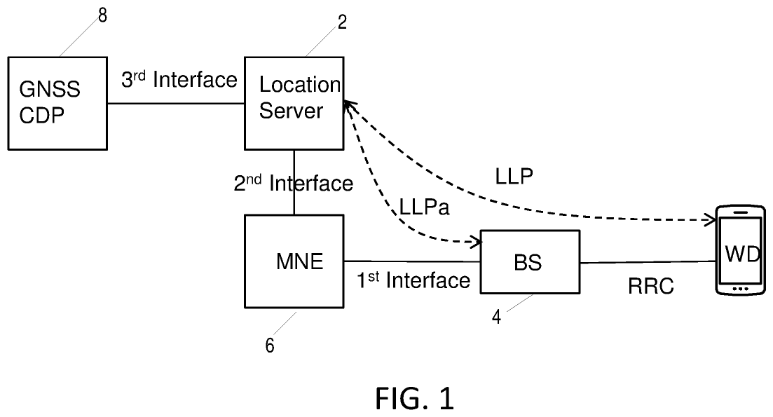

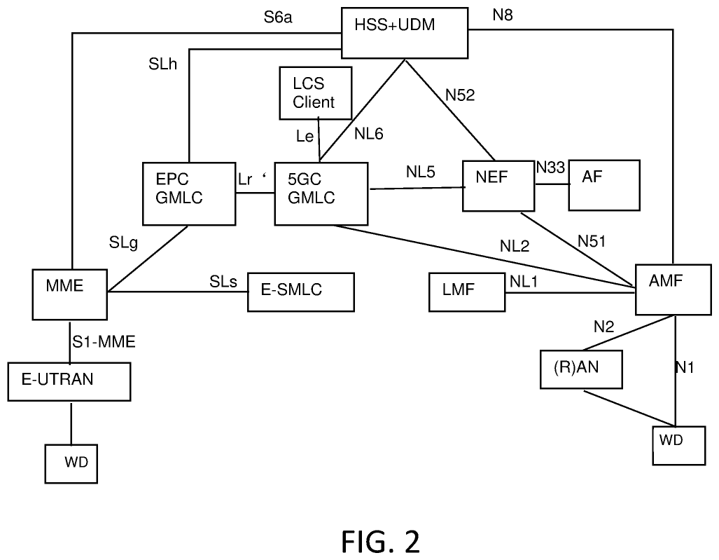

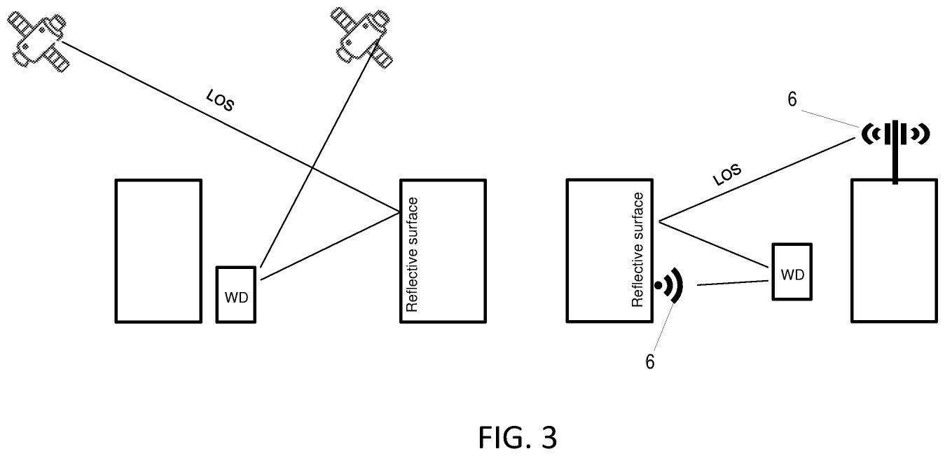

### DETAILED DESCRIPTION

A problem with the local environment measurement issues can potentially have a degrading impact on the positioning performance. It can also imply that the device (e.g., WD) estimates a position that does not correspond to the expected uncertainty, meaning that the WD can assume a more precise position than what is actually estimated, potentially causing serious implications if used in some automated or collaborative context.

Some embodiments comprise methods to crowd-source local environment measurement issues from WDs as well as to provide as assistance data regional local environment integrity indicators to WDs to handle impacts from local environment measurement issues on positioning integrity.

Some embodiments may advantageously allow that, with regional local environment integrity indicators, a WD entering a region may be prepared for measurement issues and may consider the potential negative impact from these measurement issues when assessing positioning integrity to ensure that the WD has an adequate assessment of the positioning estimate uncertainty.

Some embodiments may advantageously allow that, with crowd-sourced regional local environment measurement issues, the gathering of the information may be automated, resulting in a cost-efficient introduction and operation of local environment integrity indicators.

Before describing in detail exemplary embodiments, it is noted that the embodiments reside primarily in combinations of apparatus components and processing steps related to arrangements for wireless device (WD) feared event observations and indicators. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In some embodiments, the term “measurement issues” and/or “stored measurement issues” may be used interchangeably and may mean information about a local/regional environment that is related to and/or indicates a potential negative and/or positive impact on positioning estimate/measurement accuracy in such local/regional environment. The term “measurement issues” may be interchangeable with one or more of the terms “positioning measurement/estimation accuracy information” and “positioning measurement/estimation precision level”.

In some embodiments, the term “positioning integrity” may mean a state or quality of a local/regional environment that is related to and/or indicates a positioning accuracy that can be assumed by a device.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g., representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g., representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

Predefined in the context of this disclosure may refer to the related information being defined for example in a standard, and/or being available without specific configuration from a network or network node, e.g., stored in memory, for example independent of being configured. Configured or configurable may be considered to pertain to the corresponding information being set/configured, e.g., by the network or a network node.

In some embodiments, the term “obtain” or “obtaining” is used herein and may indicate obtaining in e.g., memory such as in the case where the information is predefined. The term “obtain” or “obtaining” as used herein may also indicate obtaining by receiving signaling indicating the information obtained.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide arrangements for wireless device (WD) feared event observations and indicators.

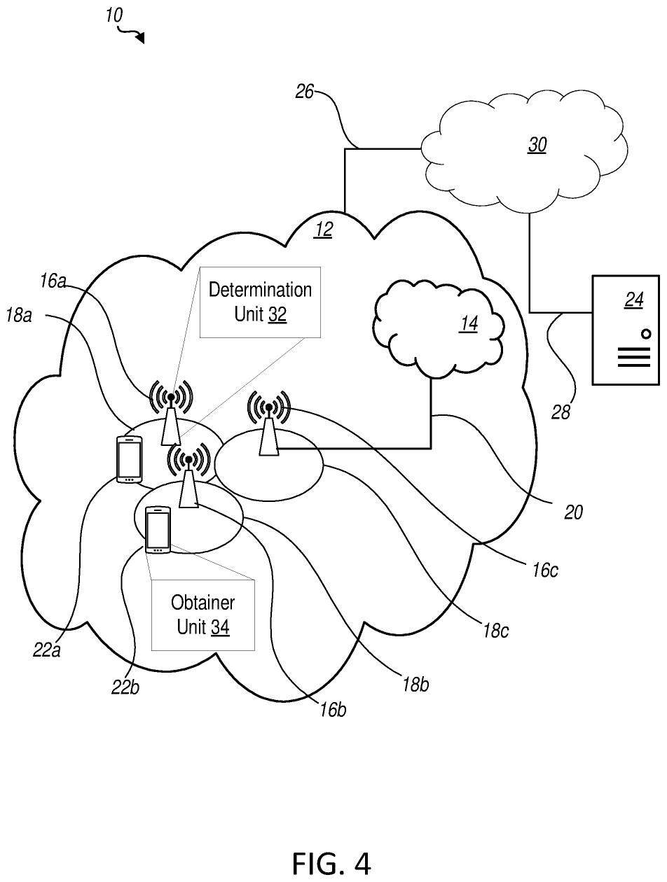

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a determination unit 32 which is configured to determine a regional local environment integrity indicator; and send the determined regional local environment integrity indicator to the wireless device.

A wireless device 22 is configured to include an obtainer unit 34 which is configured to obtain assistance data and a regional local environment integrity indicator; and determine positioning integrity based on the regional local environment indicator.

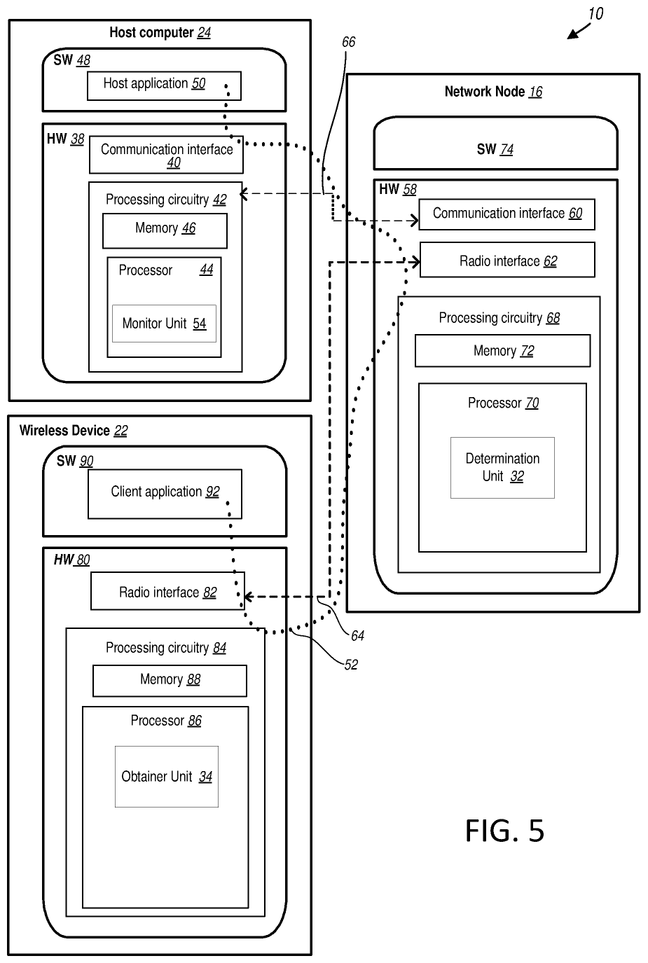

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

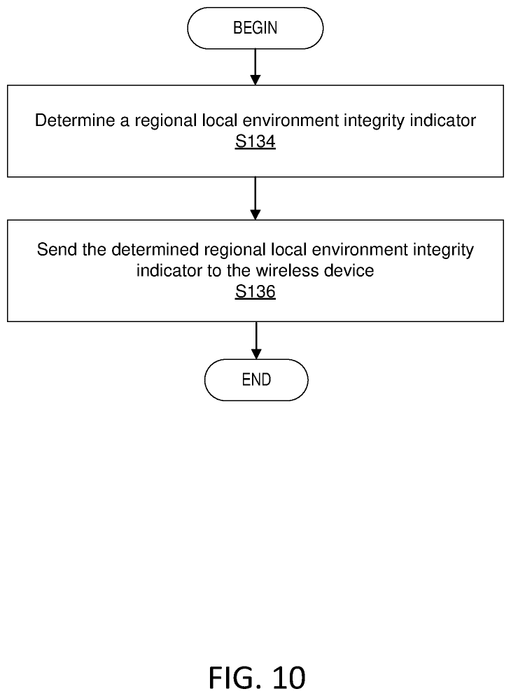

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include determination unit 32 configured to perform network node methods discussed herein, such as the methods discussed with reference to FIG. 10 as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

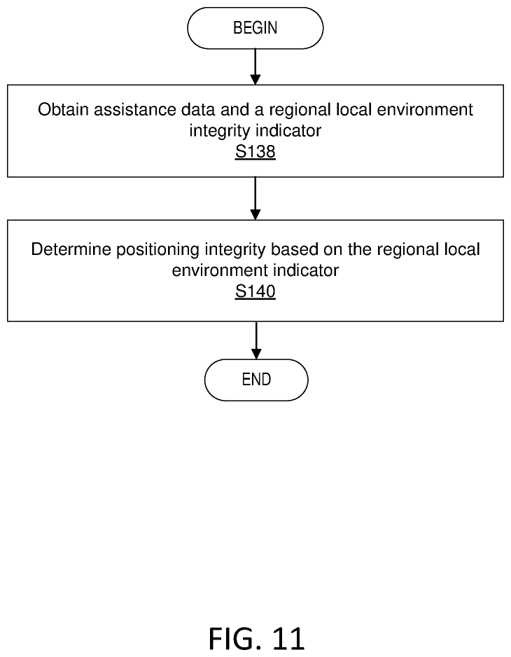

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an obtainer unit 34 configured to perform WD methods discussed herein, such as the methods discussed with reference to FIG. 11 as well as other figures.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as determination unit 32, and obtainer unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

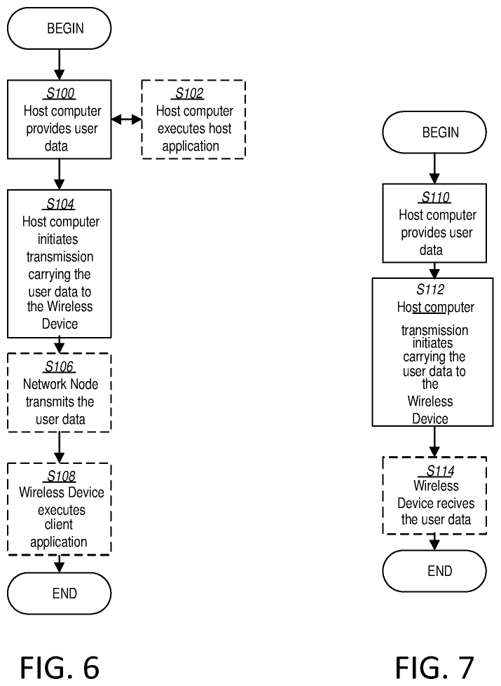

FIG. 6 is a flowchart illustrating an exemplary method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

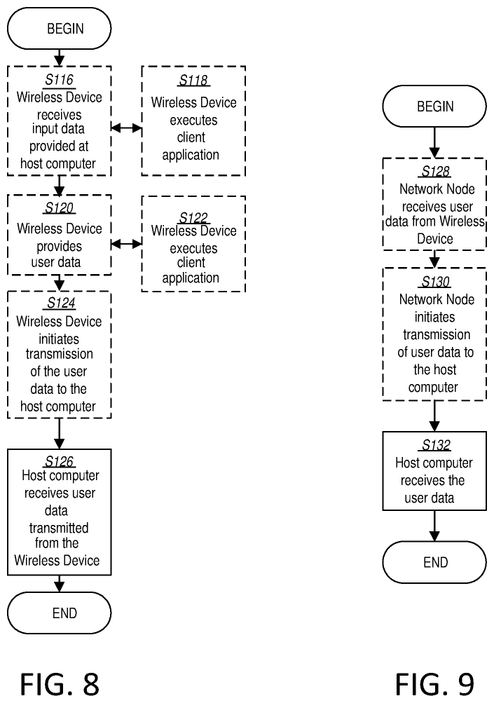

FIG. 8 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 10 is a flowchart of an exemplary process in a network node 16 according to some embodiments of the present disclosure. One or more Blocks and/or functions and/or methods performed by the network node 16 may be performed by one or more elements of network node 16 such as by determination unit 32 in processing circuitry 68, processor 70, radio interface 62, etc. according to the example method. The example method includes determining (Block S134), such as via determination unit 32, processing circuitry 68, processor 70 and/or radio interface 62, a regional local environment integrity indicator. The method includes sending (Block S136), such as via determination unit 32, processing circuitry 68, processor 70 and/or radio interface 62, the determined regional local environment integrity indicator to the wireless device 22.

In some embodiments, the method includes receiving, such as via determination unit 32, processing circuitry 68, processor 70 and/or radio interface 62, a report from the WD, the report indicating at least one local environment measurement issue, the regional local environment integrity indicator being determined based on the at least one local environment measurement issue. In some embodiments, the at least one local environment measurement issue is detected by the WD by comparing different positioning measurements and estimating at least one measurement error based on the comparison.

In some embodiments, sending, such as via determination unit 32, processing circuitry 68, processor 70 and/or radio interface 62, the regional local environment integrity indicator together with assistance data to the WD, the regional local environment integrity indicator indicating a positioning integrity associated with an estimated position of the WD, and the estimated position of the WD being based on the assistance data.

In some embodiments, receiving, such as via determination unit 32, processing circuitry 68, processor 70 and/or radio interface 62, the report from the WD as part of a Long-Term Evolution, LTE, Positioning Protocol, LPP, message and as a result of a request from the network node. In some embodiments, the request comprises a provide location information message from the network node to the WD. In some embodiments, receiving, such as via determination unit 32, processing circuitry 68, processor 70 and/or radio interface 62, the report from the WD via a radio resource control, RRC, signaling, as a result of a trigger. In some embodiments, the trigger comprises at least one a request from a mobility network entity, MNE, a measurement issue detection and an expiration of a monitoring time window.

In some embodiments, receiving, such as via determination unit 32, processing circuitry 68, processor 70 and/or radio interface 62, the report from the WD, as a result of at least one of a pre-configuration and a configuration of the WD. In some embodiments, the method further includes receiving, such as via determination unit 32, processing circuitry 68, processor 70 and/or radio interface 62, information indicating a capability of the WD to monitor and report about local environment measurement issues. In some embodiments, the information indicating the capability of the WD to monitor and report about the local environment measurement issues is pre-configured at the WD. In some embodiments, the regional local environment integrity indicator is represented by at least one of a geographical reference and a measurement issue event.

In some embodiments, the regional local environment integrity indicator is determined based on stored measurement issues.

FIG. 11 is a flowchart of an exemplary process in a wireless device 22 to some embodiments of the present disclosure. One or more Blocks and/or functions and/or methods performed by WD 22 may be performed by one or more elements of WD 22 such as by obtainer unit 34 in processing circuitry 84, processor 86, radio interface 82, etc. The example method includes obtaining (Block S138), such as via obtainer unit 34, processing circuitry 84, processor 86 and/or radio interface 82, assistance data and a regional local environment integrity indicator. The method includes determining (Block S140), such as via obtainer unit 34, processing circuitry 84, processor 86 and/or radio interface 82, positioning integrity based on the regional local environment indicator.

In some embodiments, the method further includes estimating, such as via obtainer unit 34, processing circuitry 84, processor 86 and/or radio interface 82, a position of the WD based on the determined positioning integrity. In some embodiments, the method further includes sending, such as via obtainer unit 34, processing circuitry 84, processor 86 and/or radio interface 82, a report to a network node, the report indicating at least one local environment measurement issue, the regional local environment integrity indicator being based on the at least one local environment measurement issue. In some embodiments, the method further includes detecting, such as via obtainer unit 34, processing circuitry 84, processor 86 and/or radio interface 82, the at least one local environment measurement issue by comparing different positioning measurements and estimating at least one measurement error based on the comparison. In some embodiments, sending, such as via obtainer unit 34, processing circuitry 84, processor 86 and/or radio interface 82, the report to the network node as part of a Long-Term Evolution, LTE, Positioning Protocol, LPP, message and as a result of a request from the network node.

In some embodiments, the request comprises a provide location information message from the network node to the WD. In some embodiments, sending, such as via obtainer unit 34, processing circuitry 84, processor 86 and/or radio interface 82, the report to the network node via a radio resource control, RRC, signaling, as a result of a trigger. In some embodiments, the trigger comprises at least one a request from a mobility network entity, MNE, a measurement issue detection and an expiration of a monitoring time window. In some embodiments, sending, such as via obtainer unit 34, processing circuitry 84, processor 86 and/or radio interface 82, the report to the network node, as a result of at least one of a pre-configuration and a configuration of the WD. In some embodiments, the method further includes sending, such as via obtainer unit 34, processing circuitry 84, processor 86 and/or radio interface 82, information indicating a capability of the WD to monitor and report about local environment measurement issues to the network node. In some embodiments, the information indicating the capability of the WD to monitor and report about the local environment measurement issues is pre-configured at the WD. In some embodiments, the regional local environment integrity indicator is represented by at least one of a geographical reference and a measurement issue event.

In some embodiments, the method includes estimating, such as via obtainer unit 34, processing circuitry 84, processor 86 and/or radio interface 82, a position of the WD 22 based at least in part on the determined positioning integrity.

Having described the general process flow of arrangements of the disclosure and having provided examples of hardware and software arrangements for implementing the processes and functions of the disclosure, the sections below provide details and examples of arrangements for wireless device (WD) feared event observations and indicators, which may be implemented by the network node 16, wireless device 22 and/or host computer 24.

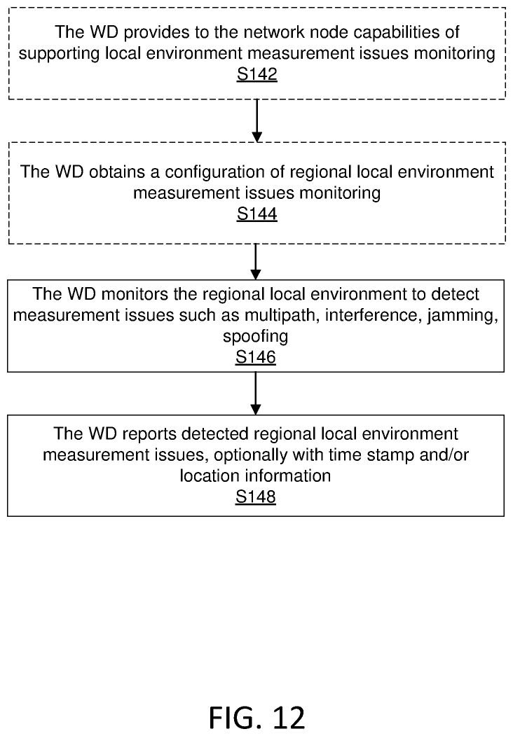

FIG. 12 illustrates some embodiments from the perspective of the WD 22 for crowd-sourcing of regional local environment measurement issues. Optionally (step S142), the WD 22 provides to the network node 16 (optionally upon request from the network node 16) capabilities for supporting monitoring and reporting of local environment measurement issues. As a capable WD 22, the WD 22 obtains (step S144) a configuration of regional local environment monitoring of measurement issues from a network node 16. The WD 22 monitors (step S146) the regional local environment to detect measurement issues such as multipath, interference, jamming, spoofing. In step S148, the WD 22 reports, to a network node 16, detected regional local environment measurement issues, optionally with time stamp and/or location information. In some embodiments, the network node 16 may be a radio base station, a location server or some other network node.

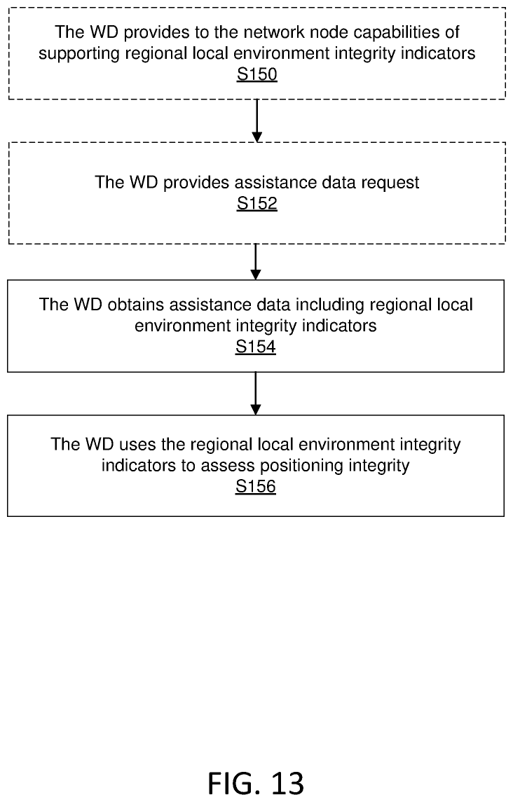

FIG. 13 illustrates some embodiments from the perspective of the WD 22 for positioning integrity assessments based on assistance data with regional and/or local environment integrity indicators. Optionally (step S150), the WD 22 provides to the network node 16 (optionally upon request from the network node 16) capabilities for supporting regional local environment integrity indicators. Furthermore, optionally (step S152), the target WD 22 provides an assistance data request to the network node 16 for positioning assistance data. In step S154, the WD 22 obtains, from the network node 16, assistance data together with regional local environment integrity indicators. In step S156, the WD 22 uses the regional local environment integrity indicators to assess positioning integrity.

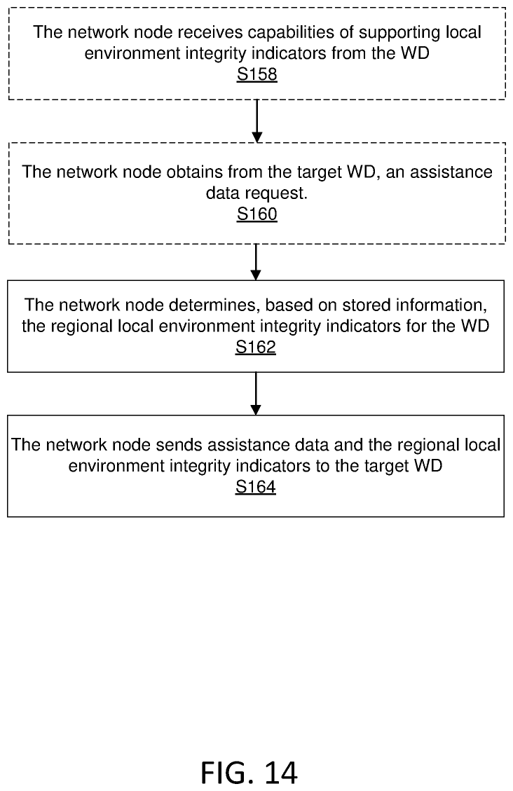

FIG. 14 illustrates some embodiments from the perspective of the network node 16 for positioning integrity assessments based on assistance data with regional local environment integrity indicators. Optionally (step 158), the network node 16 receives, from the WD 22, (optionally upon request from the network node 16) capabilities for supporting local environment integrity indicators. Furthermore, optionally (step S160), the network node 16 obtains, from the target WD 22, an assistance data request for assistance data. In step S162, the network node 16 determines, based on stored assistance data configuration, regional local environment integrity indicators. In step S164, the network node 16 provides, to the WD 22, positioning assistance data together with regional local environment integrity indicators.

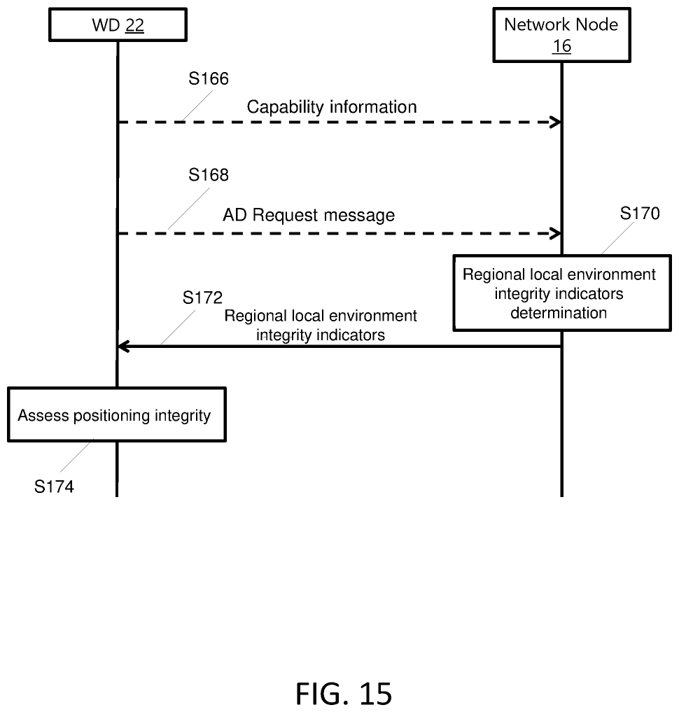

FIG. 15 provides a signaling chart of some embodiments. Optionally (step S166), the WD 22 provides to the network node 16 (optionally upon request from the network node 16) capabilities for supporting regional local environment integrity indicators. Furthermore, optionally (step S168), the target WD 22 provides an assistance data request to the network node 16 for positioning assistance data. In step S170, the network node 16 determines, based on stored assistance data configuration, regional local environment integrity indicators. In step S172, the network node 16 provides, to the WD 22, positioning assistance data together with a regional local environment integrity indicators. In step S174, the WD 22 uses the regional local environment integrity indicators to assess positioning integrity and for supporting positioning.

In some embodiments, the network node 16 is a location server, but, in other embodiments, may be a radio base station or some other network node.

Device Based Crown-Sourcing of Local Environment Measurement Issues

The crowd-sourcing of local environment measurement issues may depend on WD 22 reports as illustrated by FIG. 12, and the following configuration (step S144) and reporting (step S148) options are described in more detail:
Device configuration and reporting via LPP between a network node 16 (e.g., location server) and a WD 22;
Device configuration and reporting via RRC between a radio base station and a WD 22;
Device configuration and reporting via an over the top protocol between a network node 16 and a WD 22; and/or
Device pre-configuration and local storage in the WD 22 for subsequent upload to a network node 16.

Optionally, there is a step S142 where the WD 22 provides capabilities to the network node 16 associated to its ability to support information about local environment measurement issues.

Detecting Measurement Issues

In some embodiments, the WD 22 can be capable of detecting measurement issues. Some embodiments of such detecting (e.g., step S146) may include:
In some embodiments, the WD 22 processes all positioning measurements and uses different subsets of the positioning measurements to estimate the position and the uncertainty. By comparing the different position estimates, it is possible to identify position measurements that are associated to a less precise position estimate. Such position measurements can be associated to measurement issues such as multipath, or different forms of interference.
In some embodiments, given an estimated precise position, the WD 22 can estimate a measurement error per positioning measurement to detect measurements associated to multipath. Typically, positioning measurements subject to multipath are associated to a significant positive measurement error.

In some embodiments, depending on the positioning method, the WD 22 may retrieve different information about the local environment measurement issue, in addition to location and time stamp information.
In some embodiments, in case of GNSS, the WD 22 retrieves the GNSS type, the GNSS satellite and the GNSS signal identity. Furthermore, one or more received signal paths can have been recorded, each with specific attributes, such as a received signal arrival time, and/or path direction and/or signal strength
In some embodiments, in case of downlink positioning signals, the WD 22 retrieves the signal identifier, and optionally the different received signal paths, each optionally associated to a received signal arrival time, and/or path direction and/or signal strength.

Device Configuration and Reporting Via LPP

In case of LPP, there may be some different embodiments to realize some aspect of the invention:
In some embodiments, the network node 16 (e.g., location server) requests for local environment measurement issues as part of a RequestLocationInformation message associated to the specific positioning method, for example in case of GNSS a GNSS-RequestLocationInformation message. The WD 22 responds as part of a ProvideLocationInformation message associated to the specific positioning method, for example in case of GNSS, an A-GNSS-ProvideLocationInformation message. For RAT-dependent, there are specific corresponding messages per positioning methods such as AoD, DL-TDOA, multi-RTT, etc.
In addition to the request/provide location information messages, the WD 22 may request for assistance data, provided by the location server, and upon request from the location server provide information about its capabilities.
The network node 16 (e.g., location server) requests for local environment measurement issues as part of a CommonIEsRequestLocationInformation message, and the WD 22 reports measurement issues as part of CommonIEsProvideLocationInformation.
The network node 16 (e.g., location server) may ask the WD 22 for positioning measurements associated to a positioning method, where the network node 16 (e.g., location server) uses the reported positioning measurements to both estimate the WD 22 position and determine if the positioning measurements were subject to measurement issues.

Device Configuration and Reporting Via RRC

In case of RRC, there may be some different embodiments to realize the invention. These may be triggered by request from a mobility network entity (MNE) to the radio base station for example as part of a minimization of drive test (MDT) feature to store local environment measurement issues. The radio base station may send a measurement request to the WD 22 to report local environment measurement issues back to the radio base station. The radio base station forwards the obtained information to a network node 16 such as the MNE or a different network node 16.

Further, in some embodiments, the measurement issues result may be part of the normal RRM measurement reporting framework, where the radio base station may configure the WD 22 with a measurement report configuration. The WD 22 may be expected to trigger a measurement report when one or more of the following conditions are met;
1) A measurement issue has been detected;
2) A number of measurement issues have been detected; and/or
3) A monitoring time window has expired.

When any of the above mentioned conditions are met, in some embodiments, the WD 22 sends a measurement report to the network (immediate MDT). Alternatively, the WD 22 stores the detected measurement issues in memory and indicates to the network the availability of a measurement issues report in the WD 22 for network retrieval (logged MDT).

Device Configuration and Reporting Via an Over the Top Protocol

Similar to LPP, the WD 22 interacts with a network node 16 for configuration (e.g., step S144) and reporting (e.g., S148).

Device Pre-Configuration and Local Storage

In some embodiments, the WD 22 is pre-configured or configured via parameters in direct WD 22 user interactions (e.g., step S144) and detected measurement issues are either reported to a network node 16 directly or stored in the WD 22 and transferred in back to a network node 16 (e.g., step S148).

Network Node Based Crown-Sourcing of Local Environment Measurement Issues

In some embodiments, the network node 16 may be capable of detecting measurement issues based on positioning measurements from a WD 22. Some embodiments include one or more of the following:
The network node 16 obtains positioning measurements from a WD 22, processes all positioning measurements and uses different subsets of the positioning measurements to estimate the position and the uncertainty. By comparing the different position estimates, it is possible to identify position measurements that are associated to a less precise position estimate. Such position measurements can be associated to measurement issues such as multipath, or different forms of interference.
Given an estimated precise position, the network node 16 can estimate a measurement error per positioning measurement to detect measurements associated to multipath. Positioning measurements subject to multipath are associated to a significant positive measurement error.

Regional Local Environment Integrity Indications

Assistance Data Representation

In some embodiments, indications are described in the context of LPP, but can be generalized to other means to transfer regional local environment integrity indications.

The regional local environment integrity indications may be represented in a few different ways, such as one or more of the following:
a geographical reference:
   a logical region such as a cell, beam, tracking area, area where a reference signal is dominating other reference signals; and
   a physical region such as a location, a set of locations, a line segment, a polygon;
a measurement issue feared event:
   multipath:
      radio signal identifier such as GNSS signal identifier (ID), reference signal ID;
      frequency band;
      attributes such as time error, signal strength error, path direction error;
      ranging error, positioning error;
   interference (e.g., unintentional, jamming, spoofing):
      radio signal identifier such as GNSS signal ID, reference signal ID;
      frequency band;
      attributes such as time error, signal strength error, path direction error; and/or
      ranging error, positioning error.

Unicast

In some embodiments, the signaling is described using steps of some embodiments of the present disclosure, and applies to one or more of: LPP, RRC as well some similar client-server protocol. The LPP transactions may be the same independent of whether control plane signaling or user plane signaling via SUPL is used.

In some embodiments, from the perspective of the WD 22, FIG. 13, described above, illustrate steps of some embodiments of the present disclosure.

Broadcast

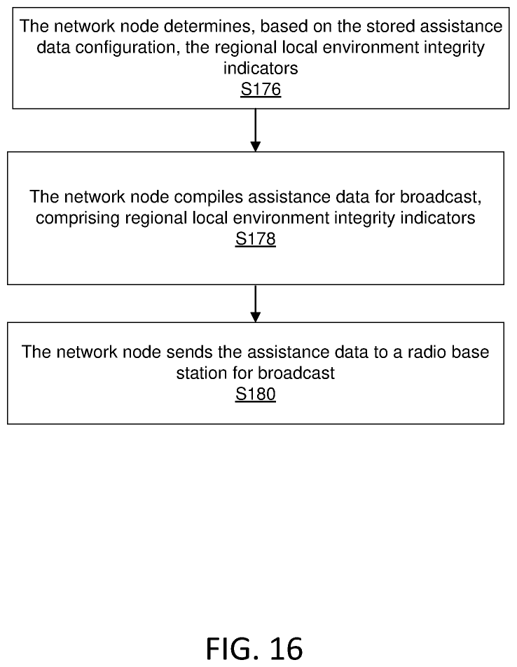

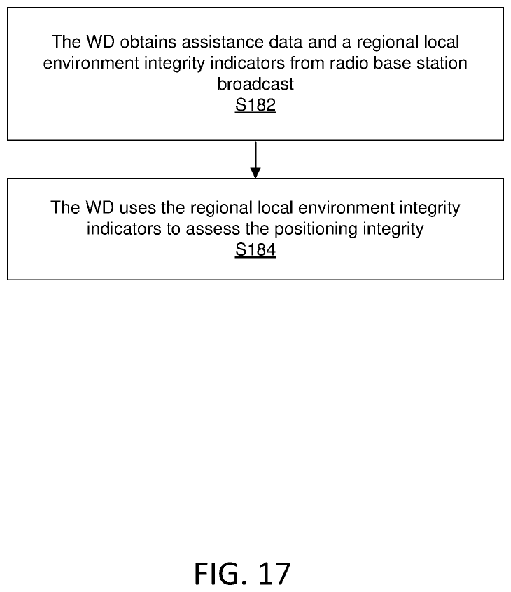

In addition, in some embodiments, the local environment integrity indication may also be broadcasted, which is described by FIG. 16. In step S176, the network node 16 determines, based on stored assistance data configuration, regional local environment integrity indicator. In step S178, the network node 16 (e.g., location server) compiles assistance data for broadcast, comprising the regional local environment integrity indications. In step S180, the network node 16 provides, to the radio base station, assistance data together with a regional local environment integrity indications.

In some embodiments, from the WD 22 perspective, in step S182, the WD 22 obtains assistance data and an assistance data resolution indicator from radio base station broadcast. In step S184, the WD 22 uses the regional local environment integrity indicator to assess positioning integrity.

Some embodiments provide a solution including a crowd sourcing of local environment measurement issues to automatically establish regional understanding of such measurement issues in a network node 16 such as a location server. Based on stored measurement issues, the network node 16 can prepare regional local environment integrity indications to warn a WD 22 about measurements feared events due to measurement issues.

In addition, some embodiments may include one or more of the following:

Embodiment A1. A network node configured to communicate with a wireless device (WD), the network node configured to, and/or comprising a radio interface and/or comprising processing circuitry configured to:
determine a regional local environment integrity indicator; and
send the determined regional local environment integrity indicator to the wireless device.

Embodiment A2. The network node of Embodiment A1, wherein the regional local environment integrity indicator is determined based on stored measurement issues.

Embodiment B1. A method implemented in a network node, the method comprising:
determining a regional local environment integrity indicator; and
sending the determined regional local environment integrity indicator to the wireless device.

Embodiment B2. The method of Embodiment B1, wherein the regional local environment integrity indicator is determined based on stored measurement issues.

Embodiment C1. A wireless device (WD) configured to communicate with a network node, the WD configured to, and/or comprising a radio interface and/or processing circuitry configured to:
obtain assistance data and a regional local environment integrity indicator; and
determine positioning integrity based on the regional location environment indicator.

Embodiment C2. The WD of Embodiment C1, wherein the WD and/or the radio interface and/or the processing circuitry is further configured to:
estimate a position of the WD based at least in part on the determined positioning integrity.

Embodiment D1. A method implemented in a wireless device (WD), the method comprising:
obtaining assistance data and a regional local environment integrity indicator; and
determining positioning integrity based on the regional location environment indicator.

Embodiment D2. The method of Embodiment D1, further comprising:
estimating a position of the WD based at least in part on the determined positioning integrity.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AMF | Access and Mobility Management Function |
| DL-PRS | Downlink positioning reference signal |
| 5GC | 5G Core |
| EPC | Evolved Packet Core |
| E-SMLC | Evolved-Serving Mobile Location Centre |
| GNSS | Global Navigation Satellite System |
| LMF | Location Management Function |
| LPP | LTE Positioning Protocol |
| LPPa | LTE Positioning Protocol Annex |
| LTE | Long Term Evolution |
| MDT | Minimization of Drive Test |
| MME | Mobility Management Entity |
| MSM | Multiple Signal Message |
| NR | New Radio |
| RRC | Radio Resource Control |
| RTK | Real Time Kinematic |
| SET | SUPL Enabled Terminal |
| SLP | SUPL Location Platform |
| SUPL | Secure User Plane Location |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a network node, the method comprising:
determining a regional local environment integrity indicator; and
sending the determined regional local environment integrity indicator to a wireless device, WD.

2. The method of claim 1, further comprising:
receiving a report from the WD, the report indicating at least one local environment measurement issue, the regional local environment integrity indicator being determined based on the at least one local environment measurement issue.

3. The method of claim 2, wherein the at least one local environment measurement issue is detected by the WD by comparing different positioning measurements and estimating at least one measurement error based on the comparison.

4. The method of claim 2, wherein sending the regional local environment integrity indicator together with assistance data to the WD, the regional local environment integrity indicator indicating a positioning integrity associated with an estimated position of the WD, and the estimated position of the WD being based on the assistance data.

5. The method of claim 2, wherein receiving the report from the WD as part of a Long-Term Evolution, LTE, Positioning Protocol, LPP, message and as a result of a request from the network node.

6. The method of claim 5, wherein the request comprises a provide location information message from the network node to the WD.

7. The method of claim 2, wherein receiving the report from the WD via a radio resource control, RRC, signaling, as a result of a trigger.

8. The method of claim 7, wherein the trigger comprises at least one a request from a mobility network entity, MNE, a measurement issue detection and an expiration of a monitoring time window.

9. The method of claim 2, wherein receiving the report from the WD, as a result of at least one of a pre-configuration and a configuration of the WD.

10. The method of claim 1, further comprising:
receiving information indicating a capability of the WD to monitor and report about local environment measurement issues.

11. The method of claim 10, wherein the information indicating the capability of the WD to monitor and report about the local environment measurement issues is pre-configured at the WD.

12. The method of claim 1, wherein the regional local environment integrity indicator is represented by at least one of a geographical reference and a measurement issue event.

13. A method implemented in a wireless device, WD, the method comprising:
obtaining assistance data and a regional local environment integrity indicator; and
determining a positioning integrity based on the regional local environment indicator.

14. The method of claim 13, further comprising:
estimating a position of the WD based on the determined positioning integrity.

15. The method of claim 13, further comprising:
sending a report to a network node, the report indicating at least one local environment measurement issue, the regional local environment integrity indicator being based on the at least one local environment measurement issue.

16. The method of claim 15, further comprising:
detecting the at least one local environment measurement issue by comparing different positioning measurements and estimating at least one measurement error based on the comparison.

17. The method of claim 15, wherein sending the report to the network node as part of a Long-Term Evolution, LTE, Positioning Protocol, LPP, message and as a result of a request from the network node.

18. The method of claim 17, wherein the request comprises a provide location information message from the network node to the WD.

19. The method of claim 15, wherein sending the report to the network node via a radio resource control, RRC, signaling, as a result of a trigger.

20. The method of claim 19, wherein the trigger comprises at least one a request from a mobility network entity, MNE, a measurement issue detection and an expiration of a monitoring time window.

21. The method of claim 15, wherein sending the report to the network node, as a result of at least one of a pre-configuration and a configuration of the WD.

22. The method of claim 13, further comprising:
sending information indicating a capability of the WD to monitor and report about local environment measurement issues to the network node.

23. The method of claim 22, wherein the information indicating the capability of the WD to monitor and report about the local environment measurement issues is pre-configured at the WD.

24. The method of claim 13, wherein the regional local environment integrity indicator is represented by at least one of a geographical reference and a measurement issue event.

25. A network node comprising processing circuitry, the processing circuitry configured to cause the network node to:
determine a regional local environment integrity indicator; and
send the determined regional local environment integrity indicator to a wireless device, WD.

26. A wireless device, WD, comprising processing circuitry, the processing circuitry configured to cause the WD to:
obtain assistance data and a regional local environment integrity indicator; and
determine a positioning integrity based on the regional local environment indicator.
